(19) United States
(12) Patent Application Publication
(10) Pub. No.: US 2024/0396436 A1
(43) Pub. Date: Nov. 28, 2024

(54) METHOD AND SYSTEM FOR WARMING-UP ELECTROLYTIC CAPACITOR

(71) Applicant: Delta Electronics (Shanghai) Co.,Ltd., Shanghai (CN)

(72) Inventors: Jinfa ZHANG, Shanghai (CN); Xiaolei WANG, Shanghai (CN)

(21) Appl. No.: 18/669,542

(22) Filed: May 21, 2024

(30) Foreign Application Priority Data
May 23, 2023 (CN) 202310588701.0
Jan. 18, 2024 (CN) 202410075038.9

(51) Int. Cl. H02M 1/42; H01G 2/08

(52) U.S. Cl. CPC H02M 1/42; H01G 2/08

(57) ABSTRACT

The disclosure provides a method and a system for warming-up an electrolytic capacitor. The method comprises: providing a power factor correction circuit comprising an AC terminal, a DC terminal and the electrolytic capacitor, wherein the DC terminal is connected in parallel to the electrolytic capacitor; determining whether it is necessary to perform a warm-up operation on the electrolytic capacitor; when it is determined to be necessary, generating a ripple current on the electrolytic capacitor by controlling an input current to flow into the AC terminal of the power factor correction circuit; and when the warmed-up state of the power factor correction circuit that is generated based on the ripple current matches a specified warmed-up exit condition, terminating the warm-up operation performed on the electrolytic capacitor.

### CROSS REFERENCE TO RELATED APPLICATION

This application claims the benefit of priority to Chinese Application No. 202310588701.0, filed on May 23, 2023 and Chinese Application No. 202410075038.9, filed on Jan. 18, 2024, the content of which is incorporated herein by reference in its entirety.

### BACKGROUND OF THE DISCLOSURE

### 1. Field of the Disclosure

The disclosure relates to the field of switching power supply technology, and particularly to a method and system for warming-up an electrolytic capacitor.

### 2. Related Art

Electrolytic capacitors are widely applied to switching power supplies, such as output capacitors of power factor correction (PFC) converters, input capacitors of inverters, and the like. However, low temperature characteristic of the electrolytic capacitor is poor, and when the temperature is relatively low, capacitance is decreased sharply, and equivalent series resistance (ESR) is increased rapidly. At this time, if a power of the load is large, it will cause a large ripple voltage on the electrolytic capacitor, easily triggering protection, and even resulting in damage of the electrolytic capacitor. Therefore, at low temperature conditions, it is necessary to warm-up the electrolytic capacitor.

Firstly, the common warm-up measures are to set the power of the load of the switching power supply to be a small value for operating a period of time, such that a core temperature of the electrolytic capacitor gradually rises. After the capacitance and the ESR are restored to a reasonable range, an output power is gradually increased to a full load. Such strategy is only adapted to the scenario where an output of the AC/DC switching power supply is connected to a load (such as, a battery) or the scenario where an output of the DC/AC switching power supply is connected to a power grid.

As for the scenario where the output load of the AC/DC switching power supply does not include a battery, if the load extracts large energy at a starting phase of the switching power supply, it easily causes a large ripple voltage of the electrolytic capacitor, thereby triggering protection. Just because a size of the load is unpredictable, and controllable energy cannot be supplied to the load, it is impossible to warm-up the electrolytic capacitor through the conventional way. Similarly, as for the scenario where the output of the DC/AC switching power supply is not connected to the power grid, it is also impossible to warm-up the electrolytic capacitor through the conventional way.

Therefore, a general mechanism for warming-up an electrolytic capacitor capable of including application scenarios, for example, the output load of the AC/DC switching power supply does not include a battery and the output of the DC/AC switching power supply is not connected to the power grid, and providing effective warm-up mechanism is required.

To sum up, the existing method has more issues in actual use, so it is necessary to make improvement.

### SUMMARY OF THE DISCLOSURE

With respect to the deficiency, an object of the disclosure is to provide a method and system for warming-up an electrolytic capacitor, which can effectively prevent the load from false start in the process of warming-up the electrolytic capacitor.

In order to achieve the object, the disclosure provides a method for warming-up an electrolytic capacitor, including:
providing a power factor correction circuit including an AC terminal, a DC terminal and the electrolytic capacitor, wherein the DC terminal is connected in parallel to the electrolytic capacitor;
determining whether it is necessary to perform a warm-up operation on the electrolytic capacitor;
when it is determined to be necessary, performing the warm-up operation, including: generating a ripple current on the electrolytic capacitor by controlling an input current to flow into the AC terminal of the power factor correction circuit;
detecting a warmed-up state of the power factor correction circuit that is generated based on the ripple current; and
when the warmed-up state matches a specified warmed-up exit condition, terminating the warm-up operation performed on the electrolytic capacitor of the power factor correction circuit.

In addition, the disclosure further provides a system for warming-up an electrolytic capacitor, for implementing the method for warming-up an electrolytic capacitor.

On the other hand, the disclosure further provides a method for warming-up an electrolytic capacitor, including:
providing a DC to DC converter including a first terminal and a second terminal, an inverter including a DC terminal and an AC terminal, and the electrolytic capacitor, the electrolytic capacitor being connected in parallel to the second terminal of the DC to DC converter and the DC terminal of the inverter, and the first terminal of the DC to DC converter being connected to a DC source;
determining whether it is necessary to perform a warm-up operation on the electrolytic capacitor;
when it is determined to be necessary, periodically performing a charging operation and a discharging operation, wherein the charging operation comprises: charging the electrolytic capacitor by the DC to DC converter; and the discharging operation comprises: discharging energy of the electrolytic capacitor by the inverter;
detecting a warmed-up state of the DC to DC converter or the inverter during the charging operation and/or the discharging operation; and
when the warmed-up state matches a specified warmed-up exit condition, terminating the charging operation and the discharging operation performed on the electrolytic capacitor.

In addition, the disclosure further provides a system for warming-up an electrolytic capacitor, for implementing another method for warming-up an electrolytic capacitor.

The method and system for warming-up an electrolytic capacitor according to the disclosure terminate the warm-up operation till satisfying the a specified warmed-up exit condition by controlling the warm-up operation performed on the electrolytic capacitor while ensuring that a load voltage is zero. Therefore, the disclosure can effectively prevent the load from false start in the process of warming-up the electrolytic capacitor.

### BRIEF DESCRIPTION OF THE DRAWINGS

FIG. 1 is a flow diagram of steps of a method for warming-up an electrolytic capacitor provided in one embodiment of the disclosure.

FIG. 2 is a block diagram of applying the method for warming-up an electrolytic capacitor in one embodiment of the disclosure to a system where an output load of an AC/DC switching power supply does not include a battery.

FIG. 3 is a topological diagram of applying the method for warming-up an electrolytic capacitor in one embodiment of the disclosure to a typical circuit where the output load of the AC/DC switching power supply does not include a battery.

FIG. 4 is a waveform diagram of the first type of signal of an AC current connected in the method for warming-up an electrolytic capacitor in one embodiment of the disclosure.

FIG. 5 is a waveform diagram of the second type of signal of an AC current connected in the method for warming-up an electrolytic capacitor in one embodiment of the disclosure.

FIG. 6 is a waveform diagram of the third type of signal of an AC current connected in the method for warming-up an electrolytic capacitor in one embodiment of the disclosure.

FIG. 7 is a flow diagram of steps of a method for warming-up an electrolytic capacitor provided in another embodiment of the disclosure.

FIG. 8 is a block diagram of applying the method for warming-up an electrolytic capacitor provided in another embodiment of the disclosure to a system where an output of a DC/AC switching power supply is not connected to a power grid.

FIG. 9 is a topological diagram of applying the method for warming-up an electrolytic capacitor provided in another embodiment of the disclosure to a typical circuit where the output of the DC/AC switching power supply is not connected to a power grid.

FIG. 10 is a PWM timing control diagram of a first example of the method for warming-up an electrolytic capacitor provided in another embodiment of the disclosure.

FIG. 11 is a PWM timing control diagram of a second example of the method for warming-up an electrolytic capacitor provided in another embodiment of the disclosure.

FIG. 12 is a PWM timing control diagram of a third example of the method for warming-up an electrolytic capacitor provided in another embodiment of the disclosure.

FIG. 13 is a PWM timing control diagram of a fourth example of the method for warming-up an electrolytic capacitor provided in another embodiment of the disclosure.

### DETAILED EMBODIMENTS OF THE DISCLOSURE

To make the object, technical solution and advantage of the disclosure clearer, hereinafter the disclosure is further explained in details with reference to the accompanying drawings and the embodiments. It shall be understood that the specific embodiments described here are only to explain the disclosure, but not limited to the disclosure.

It shall be noted that citations of “one embodiment”, “embodiments” and “exemplary embodiments” in the specification refer to that the described embodiment(s) may include specific features, structures or properties, but not every embodiment must include these specific features, structures or properties. Moreover, such expression does not refer to the same embodiment. Further, when the specific features, structures or properties are described with reference to the embodiments, no matter whether there is clear description, it has indicated that such feature, structure or property combined in other embodiments is within the knowledge range of those skilled in the art.

Moreover, the specification and subsequent claims use some phrases to refer specific assembly or component, and those ordinary in the art shall understand that manufacturers may name different nouns or terms to be the same assembly or component. The specification and subsequent claims do not use difference of names as the way of distinguishing the assembly or component, but using difference of functions of the assembly or component as the distinguishing criterion. “Comprise” and “include” mentioned in the whole specification and subsequent claims are open words, so they shall be understood to be “include but not limited to”. Moreover, when one assembly is “connected” or “coupled” to another assembly, it may be directly connected or coupled to another assembly, or may have an intervention assembly. Although the disclosed numerical range and parameters in a broad range are approximate values, the values are accurately stated as could as possible in specific examples. In addition, it can be understood that although words such as first, second and third may be used to describe different assemblies in the patent range, these assemblies shall not be limited by these words, and these assemblies correspondingly described in the embodiments are represented by signs of different assemblies. These words are used to distinguish different assemblies. For example, the first assembly may be referred to as the second assembly, and similarly, the second assembly also may be referred to as the first assembly, while not departing from the scope of the embodiments. In such way, the word and/or used includes any or all combinations of one or more relevant listed items.

The disclosure avoids the load from false start caused in the process of warming-up an electrolytic capacitor by performing a warm-up operation on the electrolytic capacitor, and controlling a voltage of the load at an output end of the switching power supply to be zero.

FIG. 1 shows a flow diagram of steps of a method for warming-up an electrolytic capacitor provided in one embodiment of the disclosure. In order to clearly describe the disclosure, this embodiment explains an example where an output load of an AC/DC switching power supply does not include a battery, but the disclosure is not limited thereto. The disclosure also can be applied to application scenarios, for example, an output end of the AC/DC switching power supply is connected to a battery, and the method includes the following steps.

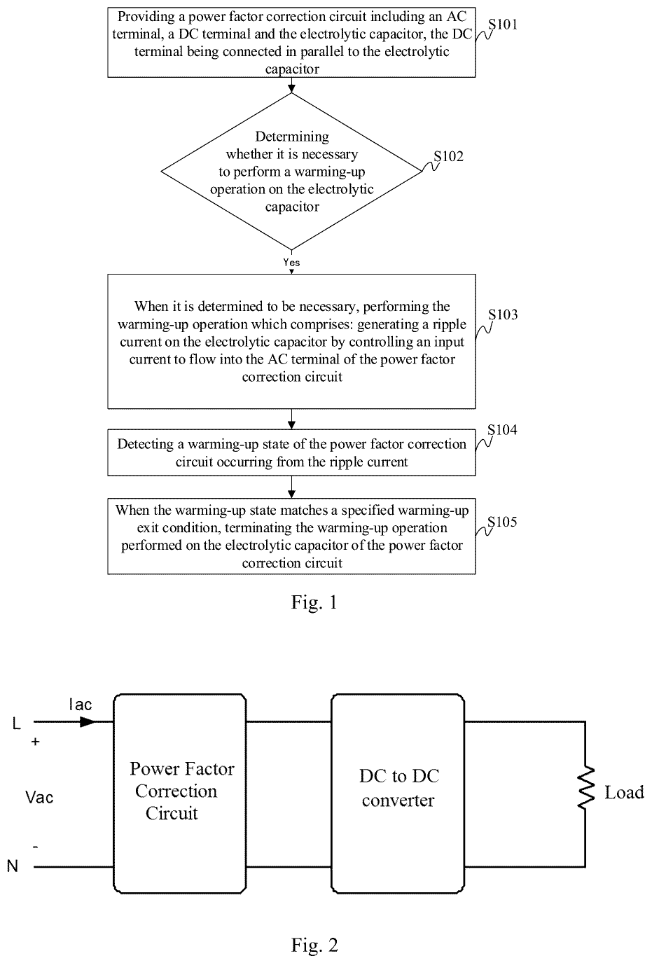

At step S101, a power factor correction circuit including an AC terminal, a DC terminal and the electrolytic capacitor is provided, wherein the DC terminal is connected in parallel to the electrolytic capacitor. FIG. 2 shows a block diagram of a system where the output load of the AC/DC switching power supply does not include a battery according to the disclosure. The AC/DC switching power supply, for example, includes two-level circuits, the first-level circuit is the power factor correction circuit. Specifically, the power factor correction circuit in this embodiment is an AC to DC converter (i.e., a PFC converter), and the electrolytic capacitor Cbus is connected in parallel to a DC terminal of the power factor correction circuit.

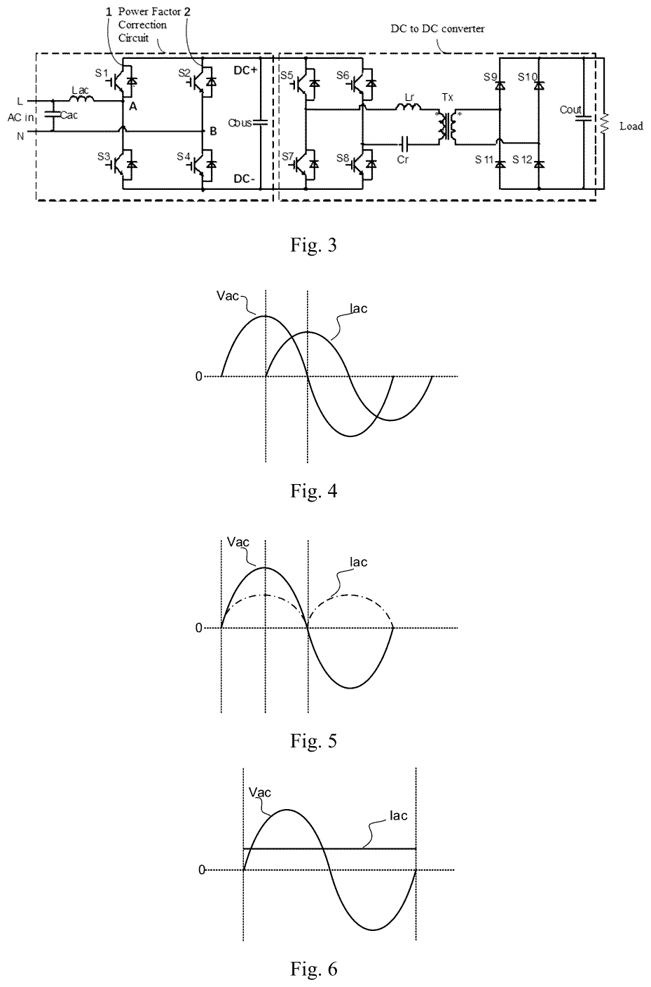

The power factor correction circuit in this embodiment is capable of bidirectional current transmission. As shown in FIG. 3, the PFC circuit, for example, is a full-bridge type topological structure, and includes a first bridge arm 1 and a second bridge arm 2 connected in parallel, the first bridge arm 1 includes a first switch S1 and a third switch S3 sequentially connected in series, and the second bridge arm 2 includes a second switch S2 and a fourth switch S4 sequentially connected in series. A connection point between the first switch S1 and the third switch S3 forms a first connection point A, a connection point between the second switch S2 and the fourth switch S4 forms a second connection point B, and an AC terminal of the PFC circuit is electrically coupled to the first connection point A and the second connection point B. A DC terminal of the PFC circuit includes a DC positive end and a DC negative end, the first bridge arm 1, the second bridge arm 2 and the electrolytic capacitor Cbus are electrically connected between the DC positive end and the DC negative end, i.e., the first bridge arm 1, the second bridge arm 2 and the electrolytic capacitor Cbus are connected in parallel to the DC terminal of the PFC circuit. Of course, in other embodiments, the PFC circuit also may have a topological structure of any one of a totem-pole type, a full-bridge type or a half-bridge type (for example, a switch in the first bridge arm 1 is replaced by a capacitor element) topological structure, or a topological structure formed by interleaving any one of the totem-pole type, the full-bridge type and the half-bridge type. As shown in FIG. 3, in some embodiments, the PFC circuit further includes a filter capacitor Cac connected in parallel to the AC terminal of the PFC circuit, and a filter inductor Lac electrically connected between the filter capacitor Cac and the first connection point A, and the filter capacitor Cac and the filter inductor Lac may be configured for filtering an input current connected to the AC terminal.

At step S102, it is determined whether it is necessary to perform a warm-up operation on the electrolytic capacitor. The characteristic of the electrolytic capacitor is poor at a low temperature. Accordingly, if the electrolytic capacitor is at low temperature conditions, it is necessary to perform a warm-up operation on the electrolytic capacitor. Therefore, in the step, it is determined whether the electrolytic capacitor is at low temperature conditions, and if yes, it is determined that it is necessary to perform a warm-up operation on the electrolytic capacitor. Otherwise, it is determined that it is unnecessary to perform the warm-up operation on the electrolytic capacitor.

In an alternative embodiment, the step S102 includes: detecting a temperature of an environment in which the electrolytic capacitor is located, which is defined as a first temperature; comparing the first temperature with a first preset temperature, and when the first temperature is less than the first preset temperature, determining that it is necessary to perform a warm-up operation on the electrolytic capacitor; when the first temperature is equal to or greater than the first preset temperature, determining that it is unnecessary to perform a warm-up operation on the electrolytic capacitor. The first preset temperature may be preset according to specific application scenarios, and in different application scenarios, the first preset temperature may be set to be different values. When a determined result of S102 is necessary, a warm-up operation in step S103 is performed; on the contrary, the flow ends.

At step S103, when it is determined to be necessary, the warm-up operation is performed, which includes: generating a ripple current on the electrolytic capacitor by controlling an input current to flow into the AC terminal of the power factor correction circuit. Specifically, the disclosure generates a ripple current on the electrolytic capacitor connected in parallel to the DC terminal of the power factor correction circuit for example through control concept such as a reactive current, while ensuring that a voltage at both ends of the load electrically coupled to the DC terminal of the power factor correction circuit is 0V, such that the electrolytic capacitor may be warmed up based on the ripple current, and also can effectively prevent the load from false start.

In an alternative embodiment, the DC terminal of the power factor correction circuit is electrically coupled to a load, and in the process of performing a warm-up operation on the electrolytic capacitor, the power factor correction circuit supplies no energy to the load. Here, the way of the power factor correction circuit not supplying energy to the load is implemented, for example, by controlling a line (or a circuit) between the power factor correction circuit and the load in a non-working state. When it is determined that a warm-up operation is necessary to be performed on the electrolytic capacitor, an input current is controlled to flow into the AC terminal of the power factor correction circuit, such that a ripple current is generated on the electrolytic capacitor, i.e., controlling the electrolytic capacitor to continuously perform charge and discharging operations, while controlling the line (or a circuit) between the DC terminal of the power factor correction circuit and the load in the non-working state, until the warm-up operation is completed.

The AC/DC switching power supply in this embodiment, for example, includes two-level circuits, the first-level circuit is the power factor correction circuit, and the second-level circuit is a DC/DC converter, i.e., a DC to DC converter. As shown in FIG. 2, the DC to DC converter is electrically connected between the electrolytic capacitor and the load. In some embodiments, the DC to DC converter can be a full-bridge LLC topological structure, and also can be a CLLC circuit, a hard switching circuit or a dual active bridge conversion circuit (DAB). When the DC to DC converter is an isolated DC to DC converter, a primary circuit in the DC to DC converter is a full-bridge type topological structure or a half-bridge type topological structure, and a secondary circuit in the DC to DC converter is a full-bridge type topological structure or a half-bridge type topological structure, but the disclosure is not limited thereto. This embodiment takes the DC to DC converter to be a full-bridge LLC topological structure for example. As shown in FIG. 3, the DC to DC converter has the primary circuit including four switches S5 to S8, and the secondary circuit including four diodes S9 to S12, the secondary circuit can be unidirectional or bidirectional, and if it is bidirectional, S9 to S12 shall be replaced by switch. The switch in the primary circuit and the secondary circuit, for example, are devices such as Si MOSFET, SiC MOSFET, IGBT or GaN. In this embodiment, the power factor correction circuit not supplying energy to the load may be implemented by controlling the DC to DC converter to be in the non-working state, and at this time, since an output voltage (i.e., a voltage at both ends of the load) of the AC/DC switching power supply is 0V, it does not cause false start of the load. Specifically, the DC to DC converter is in the non-working state till the warm-up operation ends by controlling the corresponding switch in the DC converter to be turned off, and the power factor correction circuit and the DC to DC converter cooperate to work and begins normal start by controlling the corresponding switch in the DC to DC converter to be turned on.

In this embodiment, the power factor correction circuit is a rectifier circuit, the AC terminal of the power factor correction circuit, for example, is connected to an external power grid, and a waveform of an input voltage of the power factor correction circuit is a sine wave. Further, an input current in the AC terminal (AC in) may be controlled, such that an average input power at the AC terminal in each power frequency period is OW, and since the average power is OW, an average voltage of the electrolytic capacitor Cbus remains unchanged without triggering overvoltage protection (OVP) or undervoltage protection (UVP). Meanwhile, since an instantaneous power at the AC terminal is not 0, the electrolytic capacitor Cbus necessarily has a ripple current to flow therethrough, i.e., charge and discharging operations are continuously performed on the electrolytic capacitor to warm-up the electrolytic capacitor.

In some embodiments, the AC terminal of the power factor correction circuit is controlled to flow in an input current, which at least includes three types:

The first type is that the input current Iac and the input voltage Vac of the power factor correction circuit have an equal period, and a phase difference of 90 degrees. That is, the AC current Iac and the AC voltage Vac at the AC terminal of the power factor correction circuit have an equal variation period. FIG. 4 shows waveforms of an input voltage Vac and an input current Iac having the same variation period in a power frequency period, since phases therebetween always have a difference of 90°, an average input power calculated based on the input voltage Vac and the input current Iac is OW, and although the average input power is OW, the instantaneous power is not 0, so there is a ripple current flowing the electrolytic capacitor Cbus in the process, and the electrolytic capacitor Cbus rises in temperature due to the generated ripple current.

The second type is that the input current Iac of the power factor correction circuit is a DC signal, and the period of the input voltage Vac is N times the period of the input current Iac, where N is a positive integer. FIG. 5 shows a waveform of an AC voltage Vac in one power frequency period. The AC current Iac is a DC signal, and a period of the AC voltage Vac is twice of a period of the AC current Iac, i.e., FIG. 5 has waveforms in the two periods of the AC current, and a voltage waveform of the AC voltage is an ideal sine wave, so when the AC current Iac is a DC signal, the average input power obtained according to the AC voltage Vac and the AC current Iac within one power frequency period is OW. Of course, the variation period of the input voltage Vac can be positive integer times such as once, three time, four times, or the like of the input current lac, and only if the input current Iac is a DC signal, it can be ensured that the average input power calculated within one power frequency period is OW, but the instantaneous power is not 0, so there is a ripple current flowing the electrolytic capacitor Cbus in the process, and at this time, the electrolytic capacitor Cbus rises in temperature due to the generated ripple current. The DC signal of the input current as illustrated is a full wave rectified sine wave. Of course, in other examples, the DC signal also can be a triangular wave, a square wave or a sawtooth wave.

The third type is that the input current lac of the power factor correction circuit is a constant current. That is, a magnitude and direction of the input current Iac do not change. FIG. 6 shows a waveform of an AC voltage Vac in one power frequency period, and a signal of the input current Iac is a continuous stable value. Since the AC voltage Vac is an ideal sine wave, in one power frequency period, a product between the input voltage Vac and the input current Iac is calculated to be 0, i.e., the average input power in each power frequency period is OW, but the instantaneous power is not 0, so there is a ripple current flowing the electrolytic capacitor Cbus in the process, and at this time, the electrolytic capacitor Cbus rises in temperature due to the generated ripple current.

At step S104, a warmed-up state of the power factor correction circuit that is generated based on the ripple current is detected. In the disclosure, the electrolytic capacitor Cbus rises in temperature due to the generated ripple current, and time to terminate the warm-up operation may be further clarified by detecting the warmed-up state of the power factor correction circuit that is generated based on the ripple current. In the disclosure, the warmed-up state of the power factor correction circuit that is generated based on the ripple current is, for example, a duration of the ripple current flowing on the electrolytic capacitor, and a temperature of relevant devices (such as, switch in the power factor correction circuit or the DC to DC converter) or a temperature of the electrolytic capacitor, but the disclosure is not limited thereto.

At step S105, when the warmed-up state matches a specified warmed-up exit condition, the warm-up operation performed on the electrolytic capacitor of the power factor correction circuit is terminated. The warmed-up exit conditions may be preset according to specific application scenarios. If the warmed-up state of the electrolytic capacitor reaches the warmed-up exit conditions, the warm-up operation performed on the electrolytic capacitor is completely, and the switching power supply may normally start.

In an alternative embodiment, the step S105 includes: determining whether a duration of the warm-up operation reaches a preset duration threshold, and when it is determined that the duration of the warm-up operation reaches the preset duration threshold, terminating the warm-up operation performed on the electrolytic capacitor of the power factor correction circuit. The duration threshold may be preset according to specific application scenarios. Specifically, timing begins from flowing an input current at an AC terminal of the power factor correction circuit that can generate a ripple current on the electrolytic capacitor, till countdown of the duration threshold ends, so the warm-up operation performed on the electrolytic capacitor of the power factor correction circuit is terminated, and then normal start begins.

In an alternative embodiment, the step S105 includes: determining whether a device temperature in the warm-up operation reaches a preset temperature threshold, and when it is determined that the device temperature in the warm-up operation reaches the preset temperature threshold, terminating the warm-up operation performed on the electrolytic capacitor of the power factor correction circuit. The temperature threshold may be preset according to specific application scenarios, specifically, for example, by monitoring whether the temperature of the switch in the power factor correction circuit or the DC to DC converter or the temperature of the electrolytic capacitor reaches a preset temperature threshold, if reaching the temperature threshold, the warm-up operation performed on the electrolytic capacitor of the power factor correction circuit is terminated, and then normal start begins.

Of course, in other embodiments, the warmed-up exit conditions also may satisfy the requirements of the duration threshold and the temperature threshold simultaneously.

The disclosure further provides a system for warming-up an electrolytic capacitor, for implementing the method for warming-up an electrolytic capacitor in FIG. 1 and the relevant alternative embodiments. As for the specific control process and the achieved technical effect of the system for warming-up an electrolytic capacitor in this embodiment, please refer to description of the corresponding part of the method for warming-up an electrolytic capacitor provided in the embodiment, and the details are not described here.

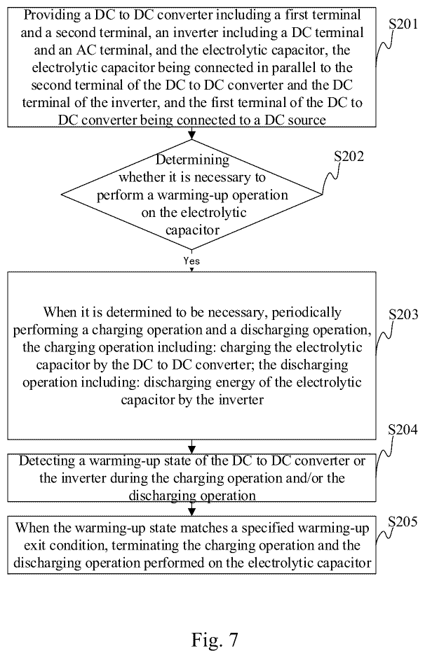

FIG. 7 shows a flow diagram of steps of a method for warming-up an electrolytic capacitor provided in another embodiment of the disclosure in order to clearly describe the disclosure. This embodiment makes explanation taking an output of a DC/AC switching power supply not connected to a power grid for example, but the disclosure is not limited thereto. The disclosure also may be applied to application scenarios, for example, an output of the DC/AC switching power supply is connected to the power grid, and the method includes the following steps.

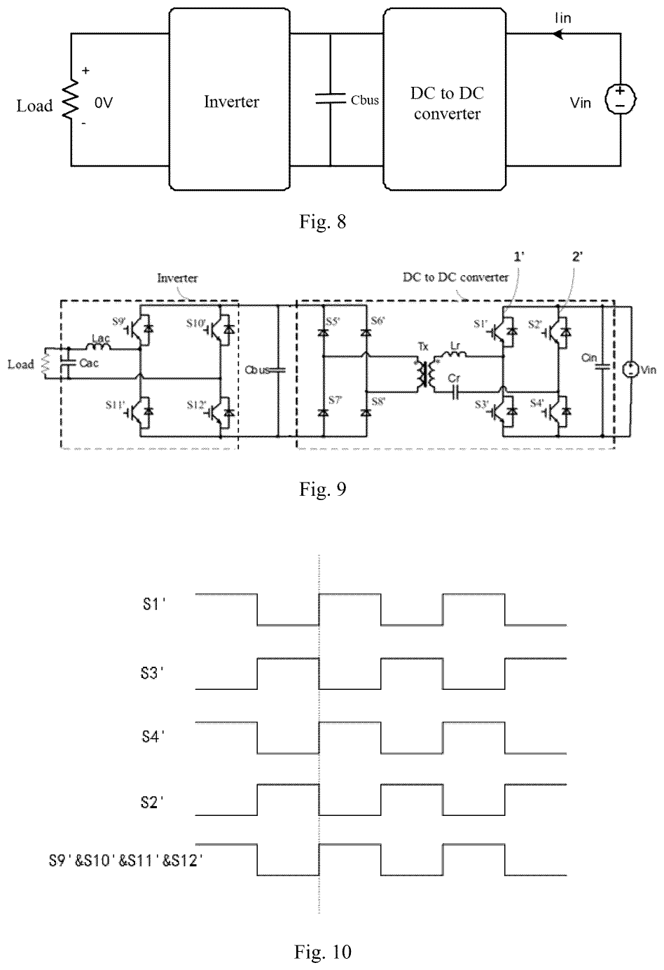

At step S201, a DC to DC converter, an inverter and the electrolytic capacitor are provided, wherein the DC to DC converter includes a first terminal and a second terminal, the inverter includes a DC terminal and an AC terminal, the electrolytic capacitor is connected in parallel to the second terminal of the DC to DC converter and the DC terminal of the inverter, and the first terminal of the DC to DC converter is connected to a DC source. FIG. 8 shows a block diagram of a system where an output end of a DC/AC switching power supply is not connected to a power grid according to the disclosure. The DC/AC switching power supply is formed of two-level circuits, the first-level circuit is the DC to DC converter, and the second-level circuit is the inverter. The DC to DC converter has a first terminal connected to a DC source Vin, and a second terminal of the DC to DC converter connected in parallel to the electrolytic capacitor Cbus and the DC terminal of the inverter, and the inverter has an AC terminal connected to a load.

In some embodiments, the DC to DC converter may be a unidirectional LLC topology, and also may be a CLLC circuit, a hard switching circuit or a DAB circuit. When the DC to DC converter is an isolated DC to DC converter, a primary circuit thereof may be a full-bridge circuit or a half-bridge circuit, and a secondary circuit may be a full-bridge circuit or a half-bridge circuit. As shown in FIG. 9, taking the DC to DC converter to be a full-bridge LLC topological structure for example, the primary circuit of the DC to DC converter includes four switches S1′ to S4′, the secondary circuit includes four diodes S5′ to S8′, the DC to DC converter can be a unidirectional circuit or a bidirectional circuit, and if it is the bidirectional circuit, the diodes S5′ to S8′ of the secondary circuit of the DC to DC converter shall be replaced by switch. The switch in the primary circuit and the secondary circuit, for example, are devices such as Si MOSFET, SiC MOSFET, IGBT or GaN. Alternatively, the inverter is a totem-pole, full-bridge or half-bridge type topological structure, or a topological structure formed by interleaving any one of the totem-pole, full-bridge or half-bridge.

At step S202, it is determined whether it is necessary to perform a warm-up operation on the electrolytic capacitor. The characteristic of the electrolytic capacitor is poor at a low temperature. Accordingly, if the electrolytic capacitor is at low temperature conditions, it is necessary to perform a warm-up operation on the electrolytic capacitor. Therefore, in this step, it is determined whether the electrolytic capacitor is at low temperature conditions, and if yes, it is determined that it is necessary to perform a warm-up operation on the electrolytic capacitor. Otherwise, it is determined that it is unnecessary to perform the warm-up operation.

In an alternative embodiment, the step S202 includes: detecting a temperature of an environment in which the electrolytic capacitor is located, which is defined as a second temperature; comparing the second temperature with a second preset temperature, and when the second temperature is less than the second preset temperature, determining that it is necessary to perform a warm-up operation on the electrolytic capacitor; when the second temperature is equal to or greater than a warming-up temperature, determining that it is unnecessary to perform a warm-up operation on the electrolytic capacitor. The second preset temperature may be preset according to specific application scenarios, and in different application scenarios, the second preset temperature may be set to be different values. When a determined result of S202 is necessary, the charging operation and the discharging operation in step S203 are performed periodically; when the determined result of S202 is unnecessary, the flow ends.

At step S203, when it is determined to be necessary, a charging operation and a discharging operation is periodically performed, wherein the charging operation includes: controlling the DC to DC converter to charge the electrolytic capacitor with energy supplied from the DC source; the discharging operation includes: discharging energy of the electrolytic capacitor by the inverter. That is, the warm-up operation is specifically to charge the electrolytic capacitor Cbus by the DC to DC converter, and discharge the electrolytic capacitor Cbus using the inverter, such that repeated charge and discharge operations are performed on the electrolytic capacitor Cbus to form a ripple current on the electrolytic capacitor Cbus, and the electrolytic capacitor Cbus may be warmed-up based on the generated ripple current.

In an alternative embodiment, the charging operation further comprises: controlling the inverter to be in an open state, and controlling the DC to DC converter to convert energy supplied from the DC source and to charge the electrolytic capacitor with the converted energy; and the discharging operation further comprises: controlling the inverter to be a short circuit state, and discharging energy transferred from the DC source through the DC to DC converter and energy of the electrolytic capacitor by using the inverter.

As shown in FIG. 9, the inverter in this embodiment, for example, is a bridge circuit (including switches S9′ to S12′), and in the step S203, the inverter is controlled to be in the open state, for example, which is implemented by controlling driving signals for the switches (S9′ to S12′) of the bridge circuit to be the same, and all in an off state. In the step S203, the inverter is controlled to be in the short circuit state, for example, which is implemented by controlling driving signals for the switches (S9′ to S12′) of the bridge circuit to be the same, and all in an on state. That is, by controlling the switch in the bridge circuit to have the same driving signal, the switch are turned on or turned off simultaneously based on the driving signal, and the inverter may be in a short circuit state or an open state correspondingly. When the inverter is in the open state, the DC to DC converter is controlled to convert energy supplied from the DC source and to charge the electrolytic capacitor with the converted energy, and when the inverter is in the short circuit state, energy transferred from the DC source via the DC to DC converter and energy of the electrolytic capacitor Cbus is discharged through the inverter. In other embodiments, the inverter also may be in the open state or the short circuit state through other control ways. Taking the inverter to be a full-bridge circuit for example, as shown in FIG. 9, for example, the inverter is in the open state by controlling the upper switches (S9′ and S10′) in the two parallel-connecting bridge arms of the full-bridge circuit to be turned off, and for example, the inverter is in the short circuit state by controlling switches (such as, S9′ and S11′) in any of the two parallel-connecting bridge arms of the full-bridge circuit to be turned on. Of course, the way of controlling the inverter in the open state is plural, and the details are not described here.

In an alternative embodiment, the DC to DC converter is an isolated DC to DC converter, and periodically performing a charging operation and a discharging operation includes: performing a control of frequency modulation and/or phase-shift angle modulation on the DC to DC converter to change gain of the DC to DC converter, then gradually increase a current flowing through a transformer in the isolated DC to DC converter, and generating a driving signals to control switches in the DC to DC converter; acquiring information about a peak value of the current flowing through the transformer, which sampled by a current transformer; controlling a peak value of the current flowing through the transformer within a preset range and to be stabilized near a preset value; and during the charging operation, charging the electrolytic capacitor with the DC to DC converter, or during the discharging operation, discharging the energy supplied from the DC to DC converter and the energy in the electrolytic capacitor by means of the inverter.

Referring to FIG. 9, the DC to DC converter, for example, is an isolated DC to DC converter, the isolated DC to DC converter includes a primary circuit including a first bridge arm 1′ and a second bridge arm 2′ connected in parallel to the DC terminal Vin, the first bridge arm 1′ includes a first switch S1′ and a third switch S3′ connected in series, and the second bridge arm 2′ includes a second switch S2′ and a fourth switch S4′ connected in series.

In the disclosure, taking the DC/AC switching power supply in FIG. 9 for example, periodically performing a charging operation and a discharging operation performed on the electrolytic capacitor at least includes the following fourth examples:

In a first example, performing a control of the frequency modulation on the DC to DC converter includes controlling the driving signals for the first switch S1′, the second switch S2′, the third switch S3′ and the fourth switch S4′ to have the same driving frequency, controlling the driving signal for the first switch S1′ and the driving signal for the third switch S3′ to be complementary, controlling the driving signal for the second switch S2′ and the driving signal for the fourth switch S4′ to be complementary, controlling the driving signal for the first switch S1′ and the driving signal for the fourth switch S4′ to be the same, and controlling the driving signal for the switches in the inverter and the driving signal for the first switch to be the same. FIG. 10 shows waveforms of driving signal for the exemplary switch in PWM timing control, where the driving frequencies for the switches S1′ to S4′ are the same, and set to be fs_d2d. Meanwhile, the driving signals for the switches S9′ to S12′ in the inverter are consistent, and the driving frequency fsw_inv is the same as the driving frequency fs_d2d of S′ to S4′, i.e., fsw_inv=fs_d2d, and the driving signals for the switches S9′ to S12′ in the inverter are the same as the driving signal for the first switch S1′. That is, this embodiment changes a magnitude of a resonant tank current by frequency modulation through the DC to DC converter, such that when the driving signals for the switches S9′ to S12′ are at high levels, that is, the inverter is in a short circuit state, energy transferred from the DC source via the DC to DC converter and energy of the electrolytic capacitor is discharged through the inverter, and when the driving signals for the switches S9′ to S12′ are at low levels, that is, the inverter is in an open state, the DC to DC converter is controlled to convert energy supplied by the DC source and to charge the electrolytic capacitor with the converted energy.

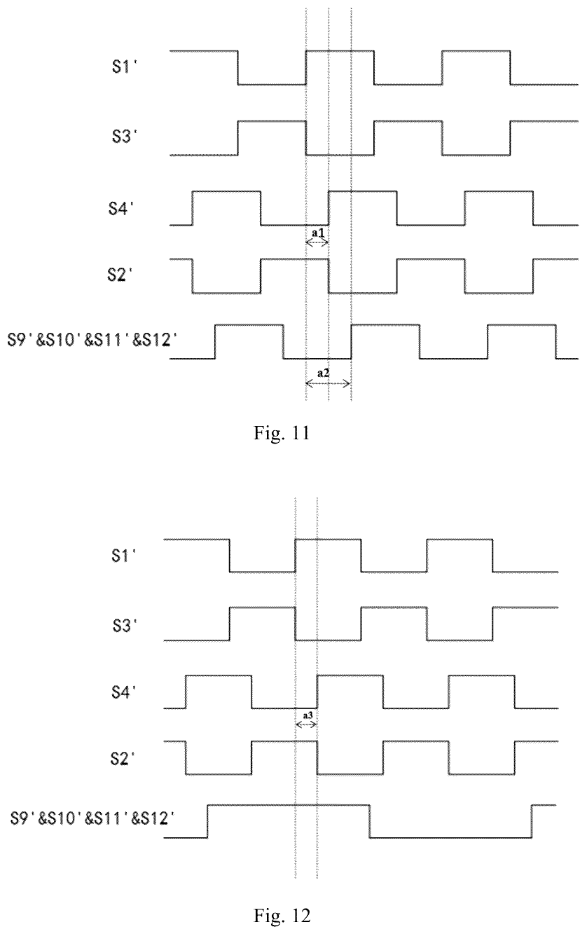

In a second example, performing a control of the frequency modulation and first phase-shift angle modulation on the DC to DC converter includes controlling the driving signals for the first switch S1′, the second switch S2′, the third switch S3′ and the fourth switch S4′ to have the same driving frequency, controlling the driving signal for the first switch S1′ and the driving signal for the third switch S3′ to be complementary, controlling the driving signal for the second switch S2′ and the driving signal for the fourth switch S4′ to be complementary, controlling the phase of the driving signal for the first switch S1′ to differ from the phase of the driving signal for the fourth switch S4′ by a first phase-shift angle a1, and controlling the driving frequency for the switches (S1′ to S4′) in the DC to DC converter be the same as the driving frequency for the switch (S9′ to S12′) in the inverter, and controlling the driving signal for each switch (S9′ to S12′) in the inverter to be identical and to have a phase differing from the phase of the driving signal for the first switch S1′ by a second phase-shift angle a2. FIG. 11 shows waveforms of driving signal for the exemplary switch in PWM timing control. Phases of the driving signal for the first switch S1′ and the driving signal for the fourth switch S4′ are controlled to be different, for example, differ by a first phase-shift angle a1, the driving frequency fsw_inv of the switches S9′ to S12′ in this example is the same as the driving frequency fs_d2d of the switches S1′ to S4′, and phases of the driving signals for the switch (S9′ to S12′) in the inverter and the driving signal for the first switch S1′ are also different, for example, differ by a second phase-shift angle a2. That is, this example changes a magnitude of a resonant tank current by frequency modulation and first phase-shift angle modulation through the DC to DC converter, such that when the driving signals for the switches S9′ to S12′ are at high levels, that is, the inverter is in the short circuit state, energy transferred from the DC source via the DC to DC converter and energy of the electrolytic capacitor may be discharged through the inverter, and when the driving signals for the switches S9′ to S12′ are at low levels, that is, the inverter is in the open state, and the DC to DC converter is controlled to convert energy supplied by the DC source and to charge the electrolytic capacitor with the converted energy.

In a third example, performing a control of the frequency modulation and third phase-shift angle modulation on the DC to DC converter includes controlling the driving signals for the first switch S1′, the second switch S2′, the third switch S3′ and the fourth switch S4′ to have the same driving frequency, controlling the driving signal for the first switch S1′ and the driving signal for the third switch S3′ to be complementary, controlling the driving signal for the second switch S2′ and the driving signal for the fourth switch S4′ to be complementary, controlling the phase of the driving signal for the first switch S1′ to differ from the phase of the driving signal for the fourth switch S4′ by a third phase-shift angle a3, controlling the driving frequencies for the switches (S1′ to S4′) of the DC to DC converter and the driving frequencies for the switches (S9′ to S12′) of the inverter to be different, and controlling the driving signals for the switches (S9′ to S12′) of the inverter to be the same. FIG. 12 shows waveforms of driving signal for the exemplary switch in PWM timing control, where a dead time is ignored, and phases of the driving signals for the first switch S1′ and the fourth switch S4′ are different, for example, differ by a third phase-shift angle a3. Meanwhile, the driving signals for the switches S9′ to S12′ in the inverter are consistent, and the driving frequency fsw_inv does not equal to the driving frequencies for the switches S1 to S4, i.e., fsw_inv/fs_d2d. That is, this example changes a magnitude of a resonant tank current by frequency modulation and third phase-shift angle modulation, such that when the driving signals for the switches S9′ to S12′ are at high levels, that is, the inverter is in the short circuit state, energy transferred from the DC source via the DC to DC converter and energy of the electrolytic capacitor may be discharged through the inverter, and when the driving signals for the switches S9′ to S12′ are at low levels, that is, the inverter is in the open state, and the DC to DC converter is controlled to convert energy supplied by the DC source and to charge the electrolytic capacitor with the converted energy.

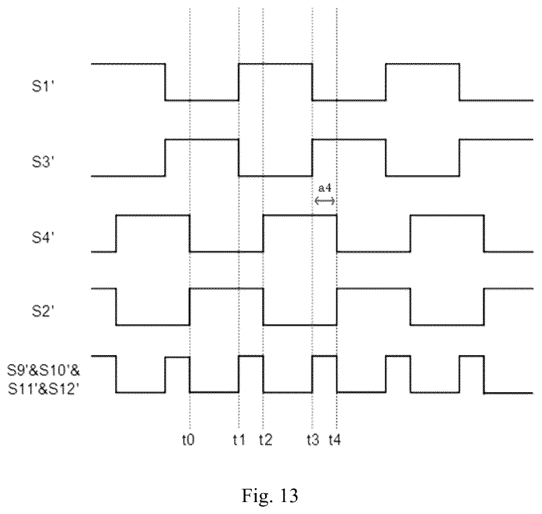

In a fourth example, performing a control of the frequency modulation and fourth phase-shift angle modulation on the DC to DC converter includes controlling the driving signals for the first switch S1′, the second switch S2′, the third switch S3′ and the fourth switch S4′ to have the same driving frequency, controlling the driving signal for the first switch S1′ and the driving signal for the third switch S3′ to be complementary, controlling the driving signal for the second switch S2′ and the driving signal for the fourth switch S4′ to be complementary, controlling the phase of the driving signal for the first switch S1′ to differ from the phase of the driving signal for the fourth switch S4′ by a fourth phase-shift angle a4; controlling the driving signal for each of the switches (S9′ to S12′) in the inverter to be identical, and controlling the driving frequency for each of the switches (S9′ to S12′) in the inverter to be twice the driving frequency for each of the switches (S1′ to S4′) in the DC to DC converter. FIG. 13 shows waveforms of driving signal for the exemplary switch in PWM timing control, where a dead time is ignored, and phases of the driving signals for the first switch S1′ and the fourth switch S4′ are different, for example, differing by a fourth phase-shift angle a4. Meanwhile, a duty ratio of each of the first switch S1′ to the fourth switch S4′ in the DC to DC converter is 50%, the driving frequency is fs_d2d, and the period is Ts. Meanwhile, the driving signal for the each of the switches S9′ to S12′ in the inverter are consistent, and its driving frequency fsw_inv is twice the driving frequencies fs_d2d for the switches S1 to S4, i.e., fsw_inv=fs_d2d*2. That is, in this example, the current in the resonant tank can be regulated by both frequency regulation and fourth phase-shift angle modulation, such that when the driving signals for the switches S9′ to S12′ are at high levels, that is, the inverter is in the short circuit state, energy transferred from the DC source via the DC to DC converter and energy of the electrolytic capacitor may be discharged through the inverter, and when the driving signals for the switches S9′ to S12′ are at low levels, that is, the inverter is in the open state, and the DC to DC converter is controlled to convert energy supplied by the DC source and to charge the electrolytic capacitor with the converted energy.

As shown in FIG. 13, the first switch S1 ‘and the third switch S3’ form a leading bridge arm, while the second switch S2 ‘and the fourth switch S4’ form a lagging bridge arm. The phase-shift angle (i.e. the fourth phase-shift angle) between the leading bridge arm and the lagging bridge arm is a4, where a4=(t2−t1)/Ts*360° or a4=(t2−t1)*fs_d2d*360°; Under the control of the fourth phase-shift angle, the phase-shift angle a4 is greater than 0° and less than 180°. As shown in FIG. 13, in a stage t0-t1, both the second switch S2 ‘and the third switch S3’ are at high levels. In a stage t2-t3, both the first switch S1 ‘and the fourth switch S4’ are at high levels. In the stages t0-t1 and t2-t3, the DC to DC converter transfers energy from the input side Vin to the electrolytic capacitor. In a stage t1-t2, both the first switch S1 ‘and the second switch S2’ are at high levels. In a stage t3-t4, both the third switch S3 ‘and the fourth switch S4’ are at high levels. In the stages t1-t2 and t3-t4, the resonant tank energy circulates on the input side. Meanwhile, when the DC to DC converter is in the stages t1-t2 and t3-t4, the driving signal for each of switches S9′-S12′ in the inverter bridge are at a low level. Accordingly, the DC to DC converter may charge the electrolytic capacitor, and the inverter does not discharge the electrolytic capacitor. As a result, all the output current from the DC to DC converter flows into the electrolytic capacitor. When the DC to DC converter is in the stages t0-t1 and t2-t3, the driving signal for each of the switches S9′-S12′ in the inverter bridge is at a high level, and the energy transferred from the DC source through the DC to DC converter and the energy on the electrolytic capacitor are discharged through the inverter. In some embodiments, the DC to DC converter operates in both control modes, i.e., the frequency modulation mode (which includes controlling the driving frequency fs_d2d of the first switch S1 ‘to the fourth switch S4’ to change simultaneously) and the fourth phase-shift angle modulation mode. Here, it is still necessary to satisfy the following condition in the inverter, i.e., discharging the electrolytic capacitor only when the resonant tank energy of the DC to DC converter is at a specified stage of the input-side circulating current. Furthermore, a duration of a high-level pulse width of each of the switches S9′-S12′ in the inverter of this example is equal to or shorter than a duration of a specified stage of the DC to DC converter. Here, the specified stage is a stage in which both the first switch S1 ‘and the second switch S2’ are at high levels, or a stage in which both the third switch S3 ‘and the fourth switch S4’ are at high levels. That is, the specified stages may be the stage t1-t2 or the stage t3-t4. Alternatively, in another embodiment, the lagging bridge arm may be formed by the first switch S1 ‘and the third switch S3’, and the leading bridge arm may be formed by the second switch S2 ‘and the fourth switch S4’, and the present invention is not specifically limited to it.

At S204, a warmed-up state of the DC to DC converter during the charging operation and/or the discharging operation is detected. In the disclosure, the electrolytic capacitor Cbus rises in temperature due to the generated ripple current (periodically performing a charging operation and a discharging operation), and time to terminate the warm-up operation may be further clarified by detecting the warmed-up state of the DC to DC converter that is generated based on the ripple current. In the disclosure, the warmed-up state of the DC to DC converter that is generated based on the ripple current, for example, is a duration of periodically performing the charging operation and the discharging operation on the electrolytic capacitor, and a temperature of relevant devices (such as, switch in the DC to DC converter or the inverter) or a temperature of the electrolytic capacitor, but the disclosure is not limited thereto.

At step S205, when the warmed-up state matches a specified warmed-up exit condition, the charging operation and the discharging operation performed on the electrolytic capacitor is terminated. The specified warmed-up exit condition are preset according to specific application scenarios, if the warmed-up state of the electrolytic capacitor reaches the a specified warmed-up exit condition, the charging operation and the discharging operation performed on the electrolytic capacitor are terminated, and then the switching power supply may normally start.

In an alternative embodiment, the step S205 includes: determining whether a duration of the warmed-up operation reaches a preset duration threshold, and when it is determined that the duration of the warm-up operation reaches the preset duration threshold, terminating the charging operation and the discharging operation performed on the electrolytic capacitor. The duration threshold may be preset according to specific application scenarios. Specifically, timing begins from the DC to DC converter performing the charge and discharging operations on the electrolytic capacitor by the way of frequency modulation and/or phase-shift angle modulation, till countdown of the duration threshold ends, so the charging operation and the discharging operation performed on the electrolytic capacitor are terminated, and then normal start begins.

In an alternative embodiment, the step S205 includes: determining whether a device temperature in the warm-up operation reaches a preset temperature threshold, and when it is determined that the device temperature in the warm-up operation reaches the preset temperature threshold, terminating the charging operation and the discharging operation performed on the electrolytic capacitor. The temperature threshold may be preset according to specific application scenarios, specifically, by monitoring whether the temperature of the switch in the inverter or the DC to DC converter or the temperature of the electrolytic capacitor reaches a preset temperature threshold, if reaching the temperature threshold, the charging operation and the discharging operation performed on the electrolytic capacitor are terminated, and then normal start begins.

Of course, in other embodiments, the warmed-up exit conditions also may satisfy the requirements of the duration threshold and the temperature threshold simultaneously.

The disclosure further provides a system for warming-up an electrolytic capacitor, for implementing the method for warming-up an electrolytic capacitor in FIG. 7 and the relevant alternative embodiments. As for the specific control process and the achieved technical effect of the system for warming-up an electrolytic capacitor in this embodiment, please refer to description of the corresponding part of the method for warming-up an electrolytic capacitor provided in the embodiment, and the details are not described here.

In conclusion, the method and system for warming-up an electrolytic capacitor according to the disclosure terminate the warm-up operation till satisfying the a specified warmed-up exit condition by controlling the warm-up operation performed on the electrolytic capacitor while ensuring that a load voltage is zero. Therefore, the disclosure can effectively prevent the load from false start in the process of warming-up the electrolytic capacitor.

Of course, the disclosure may further have various other embodiments, and those skilled in the art shall make various corresponding modifications and variations based on the disclosure without departing from spirit and essence of the disclosure, but these corresponding modifications and variations shall belong to the scope of protection of the appended claims.

What is claimed is:

1. A method for warming-up an electrolytic capacitor, comprising:
providing a power factor correction circuit comprising an AC terminal, a DC terminal and the electrolytic capacitor, wherein the DC terminal is connected in parallel to the electrolytic capacitor;
determining whether it is necessary to perform a warm-up operation on the electrolytic capacitor;
when it is determined to be necessary, performing the warm-up operation which comprises: generating a ripple current on the electrolytic capacitor by controlling an input current to flow into the AC terminal of the power factor correction circuit;
detecting a warmed-up state of the power factor correction circuit that is generated based on the ripple current; and
when the warmed-up state matches a specified warmed-up exit condition, terminating the warm-up operation performed on the electrolytic capacitor of the power factor correction circuit.

2. The method according to claim 1, wherein the power factor correction circuit is capable of bidirectional current transmission.

3. The method according to claim 1, wherein the power factor correction circuit is a rectifier circuit, and an input voltage at the AC terminal of the power factor correction circuit is a sinusoidal voltage.

4. The method according to claim 3, wherein the input current and the input voltage of the power factor correction circuit have an equal period, and a phase difference of 90 degrees.

5. The method according to claim 3, wherein the input current of the power factor correction circuit is a DC signal, and the period of the input voltage is N times the period of the input current, where N is a positive integer.

6. The method according to claim 5, wherein the input current has a waveform of a full wave rectified sine wave, a triangular wave, a square wave or a sawtooth wave.

7. The method according to claim 3, wherein the input current of the power factor correction circuit is a constant current.

8. The method according to claim 2, wherein the power factor correction circuit has a topological structure of any one of a totem-pole type, a full-bridge type or a half-bridge type, or a topological structure formed by interleaving any one of the totem-pole type, the full-bridge type and the half-bridge type.

9. The method according to claim 1, wherein the DC terminal of the power factor correction circuit is electrically coupled to a load, and when the ripple current is generated on the electrolytic capacitor, the power factor correction circuit does not supply energy to the load.

10. The method according to claim 1, wherein a DC to DC converter is electrically connected between the electrolytic capacitor and the load,
wherein supplying no energy to the load by the power factor correction circuit comprises:
controlling the DC to DC converter to be in a non-working state.

11. The method according to claim 1, wherein when the warmed-up state matches the specified warmed-up exit condition, terminating the warm-up operation performed on the electrolytic capacitor of the power factor correction circuit comprises:
determining whether a duration of the warm-up operation reaches a preset duration threshold, and
when it is determined that the duration of the warm-up operation reaches the preset duration threshold, terminating the warm-up operation performed on the electrolytic capacitor of the power factor correction circuit.

12. The method according to claim 1, wherein when the warmed-up state matches the specified warmed-up exit condition, terminating the warm-up operation performed on the electrolytic capacitor of the power factor correction circuit comprises:
determining whether a device temperature in the warm-up operation reaches a preset temperature threshold, and when it is determined that the device temperature in the warm-up operation reaches the preset temperature threshold, terminating the warm-up operation performed on the electrolytic capacitor of the power factor correction circuit,
wherein the device temperature is a temperature of the switch in the power factor correction circuit or the DC to DC converter, or a temperature of the electrolytic capacitor.

13. The method according to claim 1, wherein determining whether the warm-up operation is necessary to be performed on the electrolytic capacitor comprises:
detecting a temperature of an environment in which the electrolytic capacitor is located, which is defined as a first temperature; and
comparing the first temperature with a first preset temperature, and when the first temperature is less than the first preset temperature, determining that it is necessary to perform a warm-up operation on the electrolytic capacitor; when the first temperature is equal to or greater than the first preset temperature, determining that it is unnecessary to perform a warm-up operation on the electrolytic capacitor.

14. A system for warming-up an electrolytic capacitor, for implementing the method for warming-up the electrolytic capacitor according to claim 1.

15. A method for warming-up an electrolytic capacitor, comprising:
providing a DC to DC converter comprising a first terminal and a second terminal, an inverter comprising a DC terminal and an AC terminal, and an electrolytic capacitor, the electrolytic capacitor being connected in parallel to the second terminal of the DC to DC converter and the DC terminal of the inverter, and the first terminal of the DC to DC converter being connected to a DC source;
determining whether it is necessary to perform a warm-up operation on the electrolytic capacitor;
when it is determined to be necessary, periodically performing a charging operation and a discharging operation, wherein the charging operation comprises: controlling the DC to DC converter to charge the electrolytic capacitor with energy supplied from the DC source, and the discharging operation comprises: discharging energy of the electrolytic capacitor by the inverter;
detecting a warmed-up state of the DC to DC converter or the inverter during the charging operation and/or the discharging operation; and
when the warmed-up state matches a specified warmed-up exit condition, terminating the charging operation and the discharging operation performed on the electrolytic capacitor.

16. The method according to claim 15, wherein the charging operation further comprises: controlling the inverter to be in an open state, and controlling the DC to DC converter to convert the energy supplied from the DC source and to charge the electrolytic capacitor with the converted energy; and the discharging operation further comprises: controlling the inverter to be a short circuit state, and discharging energy transferred from the DC source through the DC to DC converter and energy of the electrolytic capacitor by using the inverter.

17. The method according to claim 16, wherein the inverter is a bridge circuit, wherein:
controlling the inverter to be in the open state comprises:
controlling each switch in the bridge circuit to be turned off such that the inverter is to be in the open state, and
controlling the inverter to be in the short circuit state comprises:
controlling each switch in the bridge circuit to be turned on such that the inverter is to be in the short circuit state.

18. The method according to claim 15, wherein the DC to DC converter is an isolated DC to DC converter, and periodically performing the charging operation and the discharging operation comprises:
performing a control of frequency modulation and/or phase-shift angle modulation on the DC to DC converter to gradually increase a current flowing through a transformer in the isolated DC to DC converter, and generating driving signals to control switches in the DC to DC converter;
acquiring information about a peak value of the current flowing through the transformer, which is sampled by a current transformer;
controlling the peak value of the current flowing through the transformer within a preset range; and
during the charging operation, charging the electrolytic capacitor with the DC to DC converter, or during the discharging operation, discharging the energy supplied from the DC to DC converter and the energy of the electrolytic capacitor by using the inverter.

19. The method according to claim 18, wherein the isolated DC to DC converter comprises a primary circuit which comprises a first bridge arm and a second bridge arm connected in parallel to the DC terminal, the first bridge arm comprising a first switch and a third switch sequentially connected in series, the second bridge arm comprising a second switch and a fourth switch sequentially connected in series, and periodically performing the charging operation and the discharging operation comprises:
performing a control of the frequency modulation on the DC to DC converter, comprising controlling the driving signals for the first switch, the second switch, the third switch and the fourth switch to have the same driving frequency, controlling the driving signal for the first switch and the driving signal for the third switch to be complementary, and controlling the driving signal for the second switch and the driving signal for the fourth switch to be complementary.

20. The method according to claim 19, wherein:
periodically performing the charging operation and the discharging operation further comprises: controlling driving signal for the switches in the inverter and the driving signal for the first switch to be the same; and
performing a control of the frequency modulation on the DC to DC converter further comprises: controlling the driving signal for the first switch and the driving signal for the fourth switch to be the same.

21. The method according to claim 19, wherein periodically performing a charging operation and a discharging operation further comprises:
performing a control of a first phase-shift angle modulation on the DC to DC converter, comprising controlling the phase of the driving signal for the first switch to differ from the phase of the driving signal for the fourth switch by a first phase-shift angle; and
controlling the driving frequency for the switches in the DC to DC converter to be the same as the driving frequency for the switches in the inverter, and controlling the driving signal for each switch in the inverter to be identical and to have a phase differing from the phase of the driving signal for the first switch by a second phase-shift angle.

22. The method according to claim 19, wherein periodically performing the charging operation and the discharging operation further comprises:
performing a control of a third phase-shift angle modulation on the DC to DC converter, comprising controlling the phase of the driving signal for the first switch to differ from the phase of the driving signal for the fourth switch by a third phase-shift angle; and
controlling the driving signal for each switch in the inverter to be identical, and controlling the driving frequency for the switches in the inverter to be different from the driving frequency for the switch in the DC to DC converter.

23. The method according to claim 19, wherein periodically performing the charging operation and the discharging operation further comprises:
performing a control of a fourth phase-shift angle modulation on the DC to DC converter,
comprising controlling the phase of the driving signal for the first switch to differ from the phase of the driving signal for the fourth switch by a fourth phase-shift angle; and
controlling the driving signal for each switch in the inverter to be identical and controlling the driving frequency for each switch in the inverter to be twice the driving frequency for each switch in the DC to DC converter.

24. The method according to claim 23, wherein a duration of a high-level pulse width duration of each switch in the inverter is equal to or shorter than a duration of a specified stage of the DC to DC converter; wherein, the specified stage is a stage in which both the first switch and the second switch are at high levels, or a stage in which both the third switch and the fourth switch are at high levels.

25. The method according to claim 24, wherein a duty ratio of each of the first switch to the fourth switch in the DC to DC converter is 50%, and the fourth phase-shift angle is equal to the duration of the high-level pulse width of each switch in the inverter multiplied by the driving frequency of the first switch in the DC to DC converter multiplied by 360°, wherein the fourth phase-shift angle is greater than 0° and less than 180 °.

26. The method according to claim 23, wherein the first switch and the third switch form a leading bridge arm, and the second switch and the fourth switch form a lagging bridge arm; or
the first switch and the third switch form a lagging bridge arm, while the second switch and the fourth switch form a leading bridge arm.

27. The method according to claim 15, wherein when the warmed-up state matches the specified warmed-up exit condition, terminating the charging operation and the discharging operation performed on the electrolytic capacitor comprises:
determining whether a duration of the warmed-up operation reaches a preset duration threshold, and when it is determined that the duration of the warmed-up operation reaches the preset duration threshold, terminating the charging operation and the discharging operation performed on the electrolytic capacitor.

28. The method according to claim 15, wherein when the warmed-up state matches the specified warmed-up exit condition, terminating the charging operation and the discharging operation performed on the electrolytic capacitor comprises:
determining whether a device temperature in the warmed-up operation reaches a preset temperature threshold, and when it is determined that the device temperature in the warmed-up operation reaches the preset temperature threshold, terminating the charging operation and the discharging operation performed on the electrolytic capacitor,
wherein the device temperature is a temperature of the switch in the DC to DC converter or the inverter, or a temperature of the electrolytic capacitor.

29. The method according to claim 15, wherein determining whether it is necessary to perform a warm-up operation on the electrolytic capacitor comprises:
detecting a temperature of an environment in which the electrolytic capacitor is located, which is defined as a second temperature; and
comparing the second temperature with a second preset temperature, and when the second temperature is less than the second preset temperature, determining that it is necessary to perform a warm-up operation on the electrolytic capacitor; and when the second temperature is equal to or greater than the second preset temperature, determining that it is unnecessary to perform a warm-up operation on the electrolytic capacitor.

30. The method according to claim 15, wherein the DC to DC converter is a LLC circuit, a CLLC circuit, a hard switching circuit or a DAB circuit, and/or, wherein the inverter has a topological structure of any one of a totem-pole type, a full-bridge type or a half-bridge type, or a topological structure formed by interleaving any one of the totem-pole type, the full-bridge type and the half-bridge type.

31. A system for warming-up an electrolytic capacitor, for implementing the method according to claim 15.
